(19) United States
(12) Patent Application Publication
(10) Pub. No.: US 2009/0031045 A1
(43) Pub. Date: Jan. 29, 2009

(54) INFORMATION RELAY DEVICE, INFORMATION RELAY METHOD, INFORMATION RELAY PROGRAM AND INFORMATION RECORDING MEDIUM

(75) Inventors: Myrine Maekawa, Saitama (JP); Kinya Ohno, Saitama (JP); Kunihiro Minoshima, Saitama (JP); Masao Higuchi, Saitama (JP)

Correspondence Address: SUGHRUE MION, PLLC, 2100 PENNSYLVANIA AVENUE, N.W., SUITE 800, WASHINGTON, DC, 20037, US

(73) Assignee: Pioneer Corporation, Meguro-ku, Tokyo (JP)

(21) Appl. No.: 11/816,735

(22) PCT Filed: Feb. 22, 2006
(86) PCT No.: PCT/JP2006/303117

§ 371 Date: Nov. 8, 2007

(30) Foreign Application Priority Data
Feb. 23, 2005 (JP) 2005-046656

(51) Int. Cl. G06F 15/16; H04L 12/00

(52) U.S. Cl. 709/249

(57) ABSTRACT

A network connection control device is provided that is capable of quickly and accurately executing the process for connection when connecting together networks that both comply to the IEEE 1394 standard. After networks that both comply to the IEEE 1394 standard are connected together and a bus reset occurs, as the contents of the route maps M_{1A}, M_{1B}, M_{2A} and M_{2B} that are stored in the respective portals 1A, 1B, 2A and 2B are updated, GUID, which indicates any one of the portals in the network group G, is used to generate bus ID information for the newly created bus.

### TECHNICAL FIELD

This invention relates to a network connection control device, network connection control method, network connection control program and information recording medium, and more particularly to a network connection control device and network connection control method that perform processing for connection control when forming a network group by connecting together a plurality of networks, a network connection control program for that connection control process, and an information recording medium on which that network connection control program is recorded.

### BACKGROUND ART

In recent years, products that comply with the USB (Universal Serial Bus) standard, and IEEE 1394 (IEEE (Institute of Electrical Electronics Engineers) 1394-1995 Standard for High Performance Serial Bus) standard as standards for simple wired connections of various external devices to a personal computer have become widely popular, and particularly, products that comply with the preferred IEEE 1394 standard for wired connections of audio and video equipment, or of audio and video equipment and a personal computer have become common.

Here, in the IEEE 1394 standard, each item of equipment such as audio and video equipment or a personal computer is typically referred to as a ‘node’, and a serial network is formed by connecting nodes with a bus that complies with the standard. In that serial bus network, each node has its own node ID (Identification) information (typically referred to as GUID (Global Unique ID)) that is unique with respect to all other devices and not just those of that serial bus network. Moreover, two nodes in the serial network are connected together by a bus (serial bus) as a physical connecting line, and a network is formed by repeatedly performing this kind of connection.

Common bus ID information is uniformly given to each of the busses in one serial network (these can be physical or another kind of connection line). Therefore, the serial bus network described above is constructed from a plurality of nodes that are serially connected by busses each having the same bus ID information (hereafter this kind of serial bus network will be referred to as simply a network unit).

On the other hand, needless to say, networks that are constructed in compliance with the IEEE 1394 standard are connected together by nodes included in each. In this case, the nodes that are used for this kind of connection (nodes that are included in each network unit) are typically called ‘portals’. Also, devices that form these connection units are regulated so that a plurality of portals is connected together by closed communication lines (internal bus, etc.) on the inside of the devices, and these portals become relay devices between network units called ‘bridges’ that comprise a plurality of portals. Here, the portals inside a bridge are not connected by busses that comply with IEEE 1394, so in the end, when a different network unit is connected by the bridge, each of the network units are independent of each other according to the IEEE 1394 standard. Here, a network that is formed by connecting network units that are constructed by busses each having common bus ID information as described above will be hereafter be referred to as a network. The network itself is regulated so that it has its own network ID information, and that specification is set separately from the IEEE 1394 standard as standard IEEE 1394.1, and a bridge specified by this IEEE 1394.1 standard is disclosed in the following two patent documents:

Japanese patent application H11-220485

Japanese patent application 2000-165417

Also, according to standard IEEE 1394.1, a constantly updated route map containing routing information that indicates the current state of use of each bus in the network is stored in each of the portals of a network. The state of use referred to here is one of four states; ‘unused’, ‘not usable as a bus’, ‘currently being used as a bus, and information cannot be transferred’ or ‘currently being used as a bus, and information can be transferred’. In the states of use, the term ‘being used as a bus’ device that there is already a bus in the network unit or network that has the same bus ID information; ‘information can be transferred’ device that by transferring information from a bus that is directly connected to the object portal to a co-portal, information can be transferred from that portal to a desired bus beyond that co-portal as seen from that portal’; furthermore, ‘information cannot be transferred’ device that even when information is transferred from a bus that is directly connected to the object portal to a co-portal, that information cannot be transferred because there is no desired bus beyond that co-portal as seen from that portal.

According to the prior IEEE 1394 standard, in regards to the bus ID information described above, after a plurality of network units has been connected by bridges to form one network, when a different network unit having bus ID information with the same value is used within that network, it is not possible to identify that network unit, and information cannot be transferred over the busses of each of the network units, so a network unit that includes a bus having bus ID information with the same value can exist in only one network and does not exist in another network.

Two or more networks that are formed in this way by connecting two or more network units together will hereafter be referred to as a network group. A network group itself is standardized by having network ID information. There is a plurality of networks existing inside a network group, and up to the time that a network group is formed, each of the networks had network ID information that differed from that of the other networks, however, after each of those networks has been brought together to form a network group, the same network ID information is assigned for the entire network group, and the networks that have been combined together in that network group no longer have their original network ID information after being combined.

On the other hand, in the prior IEEE 1394.1 standard described above, in regards to bus ID information, the standard is simply specified as ‘unique in one network’, or in other words, between different networks (including each of a plurality of network units) it is possible for the same bus ID information to exist in each network.

Also, when a network group is formed by connecting networks comprising network units that comprise busses having the same bus ID information, after connection, there are two or more network units in one network group having the same bus ID information, and the new network group that is formed after that connection no longer complies with the IEEE 1394.1 standard.

Therefore, conventionally, in a so-called net update process (in other words, a process for making the transmission of information within a formed network group comply with the IEEE 1394.1 standard, and that includes a process of updating the aforementioned route map contents when two networks are connected to form a new network group), which is set to be executed when connecting these two networks, a preset interim value is temporarily assigned to busses having the same bus ID information, and during update of the route map for each portal after bus reset, new and unique bus ID information is assigned in the place of each of the interim values. More specifically, a value such as ‘3FFh’ (the ‘h’ indicates a hexadecimal value) is assigned as the interim value referred to here, however, this value itself is only valid in communication between nodes in one network unit that complies with the conventional IEEE 1394.1 standard, or in other words, it is a value that is invalid for transmission of information beyond a bridge.

### DISCLOSURE OF THE INVENTION

### Problems to be Solved by the Invention

Therefore, in a conventional connection between networks as described above, there is a problem in that up until the time that the route map update process described above is completed for all route maps, and valid bus ID information has been assigned for all busses, the transmission of control information and the like by way of each network unit is temporarily stopped.

Also, according to the conventional method of connecting networks described above, control information, such as the route maps stored in all of the portals that belong to a network group after connection, is all newly rewritten by the net update process that accompanies the bus reset process, so as a result, there is a problem in that the update process for that control information becomes complicated, and when performing the control information update process, it is necessary to transfer information that accompanies the bus reset process to each bus, and it becomes easy for the network group that comprises those busses to become unstable.

More specifically, the unstable network group referred to here device that when the bus reset described above occurs, transmission of information over a bus is temporarily stopped, or it becomes easy for a state to occur in which the amount of information that is transmitted after bus reset increases, and in the IEEE 1394.1 standard, the effect of the bus reset spreads over the entire network (or network group) when executing the control information update process.

Taking the aforementioned problems into consideration, it is the object of the present invention to provide a network connection control device, network connection control method, network connection control program for the connection control process, and an information recording medium on which the network connection control program is recorded that are capable of quick and stable connection processing when connecting networks together that comply to the IEEE 1394.1 standard.

### Means for Solving the Problems

To solve the problems, the invention described in claim 1 is an information relay device that connects networks that are constructed such that they include busses that are identified by one bus ID (Identification) information, and includes a number of connection devices equal to the number of networks that are directly connected to the busses of the networks, and by connecting the connection devices connects the networks that are directly connected to the connection devices, and is provided with an update device for updating the bus ID information that corresponds to the busses to which the connection devices included in the information relay device are directly connected, so that when the networks are connected together to form a new network group, the bus ID information that corresponds to the busses of the new network group is different from each other.

To solve the problems, the invention described in claim 2 is an information relay device that connects networks that are constructed such that they include busses that are identified by one bus ID information, and includes a number of connection devices equal to the number of networks that are directly connected to the busses of the networks, and by connecting the connection devices connects the networks that are directly connected to the connection devices, and is provided with an update device for updating the bus ID information that corresponds to the busses to which the connection devices that are included in the information relay device are directly connected, so that when disconnecting any the network from an already formed network group that includes a plurality of the networks, the bus ID information that corresponds to each of the busses belonging to the network group after the network has been disconnected is different from each other in the network group after disconnection of the network.

To solve the problems, the invention described in claim 12 is an information relay method that is executed by an information relay device that connects networks that are constructed such that they include busses that are identified by one bus ID information, and includes a number of connection devices equal to the number of networks that are directly connected to the busses of the networks, and by connecting the connection devices connects the networks that are directly connected to the connection devices, and is provided with an update process of updating the bus ID information that corresponds to the busses to which the connection devices included in the information relay device are directly connected, so that when the networks are connected together to form a new network group, the bus ID information that corresponds to the busses of the new network group is different from each other.

To solve the problems, the invention described in claim 13 is an information relay method that is executed by an information relay device that connects networks that are constructed such that they include busses that are identified by one bus ID information, and includes a number of connection devices equal to the number of networks that are directly connected to the busses of the networks, and by connecting the connection devices connects the networks that are directly connected to the connection devices, and is provided with an update device for updating the bus ID information that corresponds to the busses to which the connection devices that are included in the information relay device are directly connected, so that when disconnecting any the network from an already formed network group that includes a plurality of the networks, the bus ID information that corresponds to each of the busses belonging to the network group after the network has been disconnected is different from each other in the network group after disconnection of the network.

To solve the problems, the invention described in claim 14 is an information relay program that causes a computer, which is included in an information relay device that connects networks that are constructed such that they include busses that are identified by one bus ID information, and includes a number of connection devices equal to the number of networks that are directly connected to the busses of the networks, and by connecting the connection devices connects the networks that are directly connected to the connection devices, to function as an update device for updating the bus ID information that corresponds to the busses to which the connection devices included in the information relay device are directly connected, so that when the networks are connected together to form a new network group, the bus ID information that corresponds to the busses of the new network group is different from each other.

To solve the problems, the invention described in claim 15 is that a computer, which is included in an information relay device that connects networks that are constructed such that they include busses that are identified by one bus ID information, and includes a number of connection devices equal to the number of networks that are directly connected to the busses of the networks, and by connecting the connection devices connects the networks that are directly connected to the connection devices, functions as an update device for updating the bus ID information that corresponds to the busses to which the connection devices that are included in the information relay device are directly connected, so that when disconnecting any the network from an already formed network group that included a plurality of the networks, the bus ID information that corresponds to each of the busses belonging to the network group after the network as been disconnected is different from each other in the network group after disconnection of the network.

To solve the problems, the invention described in claim 16 is that the information relay program of claim 14 or claim 15 is recorded so that it can be read by the computer.

### BRIEF DESCRIPTION OF THE DRAWINGS

FIG. 1 is a block diagram showing the construction of a network of an embodiment of the invention.

FIG. 2 is a block diagram showing the detailed construction of the portals that are included in the network of an embodiment of the invention.

FIG. 3 is a drawing (I) that shows the contents of the route maps in the portals when three network units of an embodiment of the invention are connected.

FIG. 4 is a drawing (II) that shows the contents of the route maps in the portals when three network units of an embodiment of the invention are connected.

FIGS. 5A and 5B are flowcharts that show the connection control process of an embodiment of the invention.

FIG. 6 is a drawing (I) showing the transition of the route maps when executing the connection control process.

FIG. 7 is a drawing (II) showing the transition of the route maps when executing the connection control process.

FIG. 8 is a drawing (III) showing the transition of the route maps when executing the connection control process.

FIG. 9 is a drawing (IV) showing the transition of the route maps when executing the connection control process.

FIG. 10 is a drawing explaining the effect when the connection control process of an embodiment of the invention is executed.

### DESCRIPTION OF REFERENCE NUMERALS

1, 2, 3, bridge
1A, 1B, 2A, 2B, 3A, 3B portal
10, 11, 12, 13, 14 bus
20 route map information
21 network ID information
22 local bus ID information
51 control unit
52 memory
M_{1A}, M_{1B}, M_{2A}, M_{2B}, M_{3A}, M_{3B} route map
100, 101, 102, 103 node
G, GG network group
NU100, MU101, NU102, NU103 network unit
N network

### BEST MODE FOR CARRYING OUT THE INVENTION

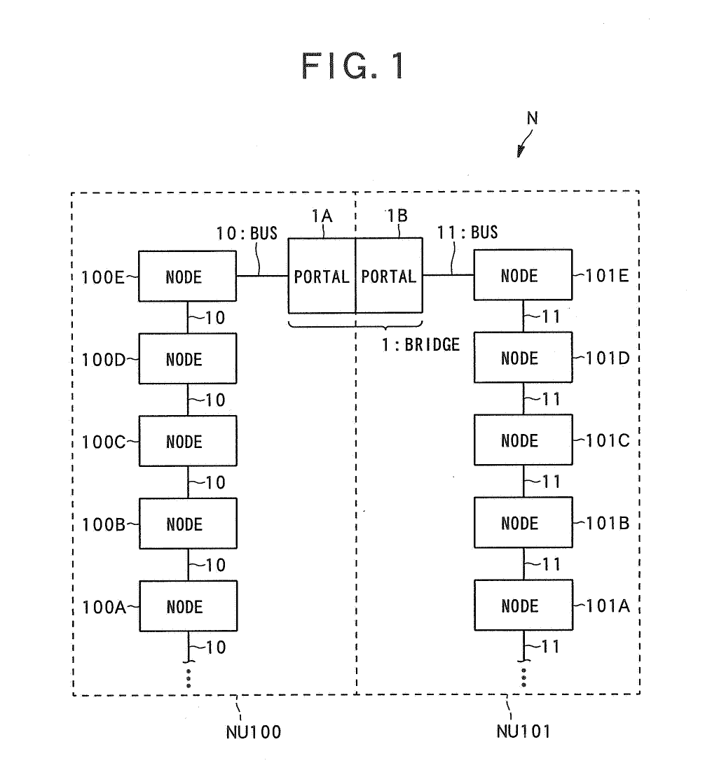

Next, the preferred embodiments of the invention will be explained using FIG. 1 to FIG. 10. The embodiments explained below are for the case in which the present invention is applied to a connection control process when using bridges to connect a plurality of networks to form a new network group.

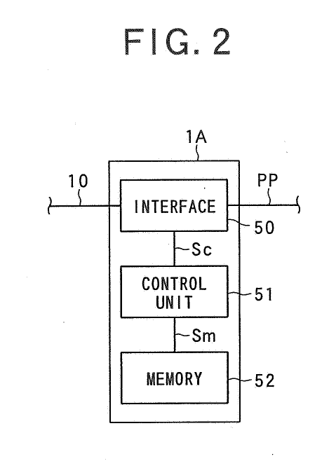

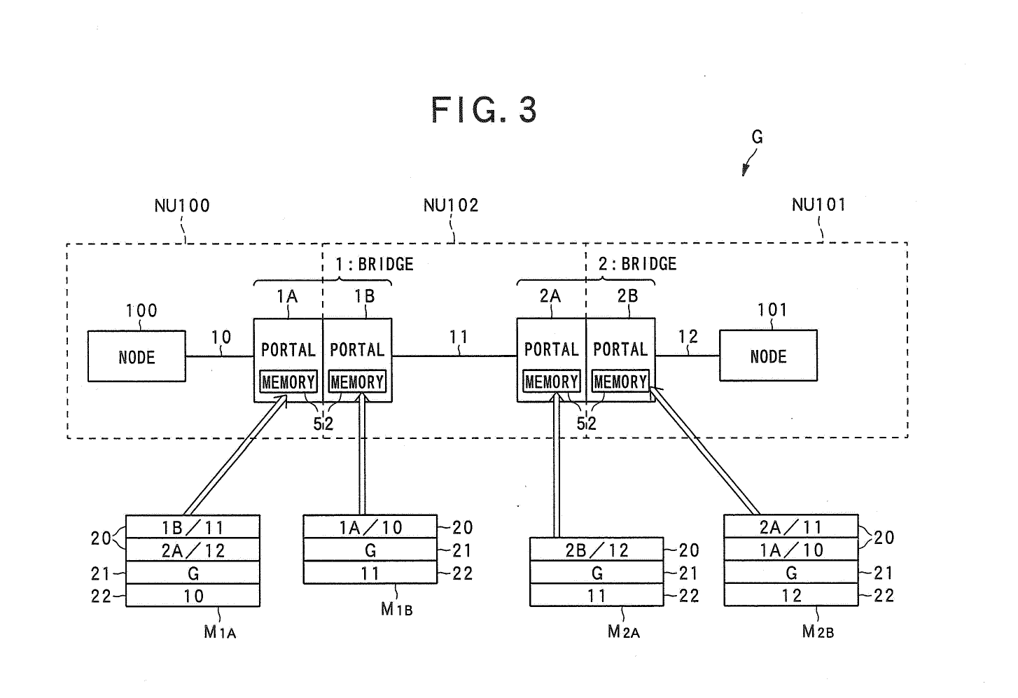

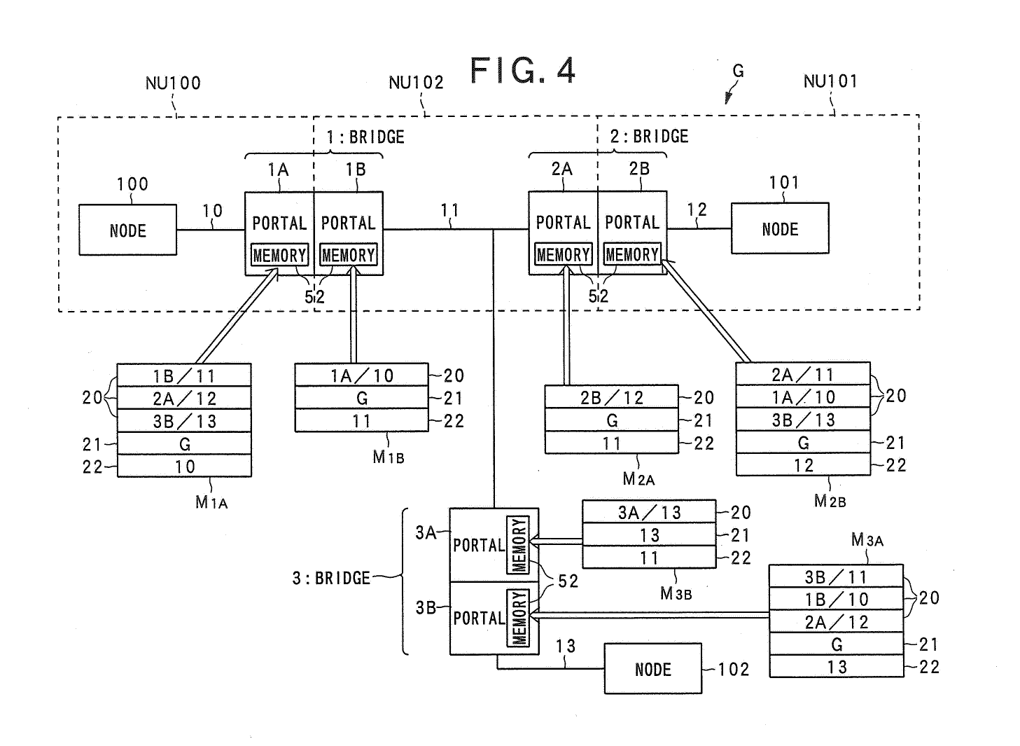

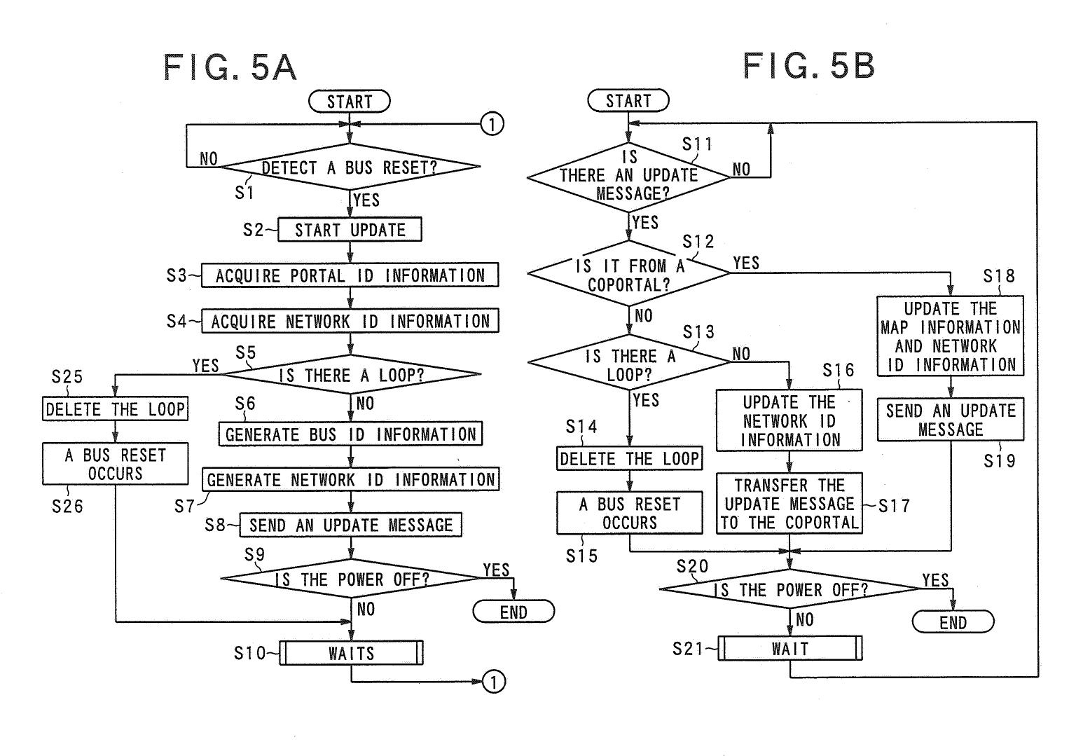

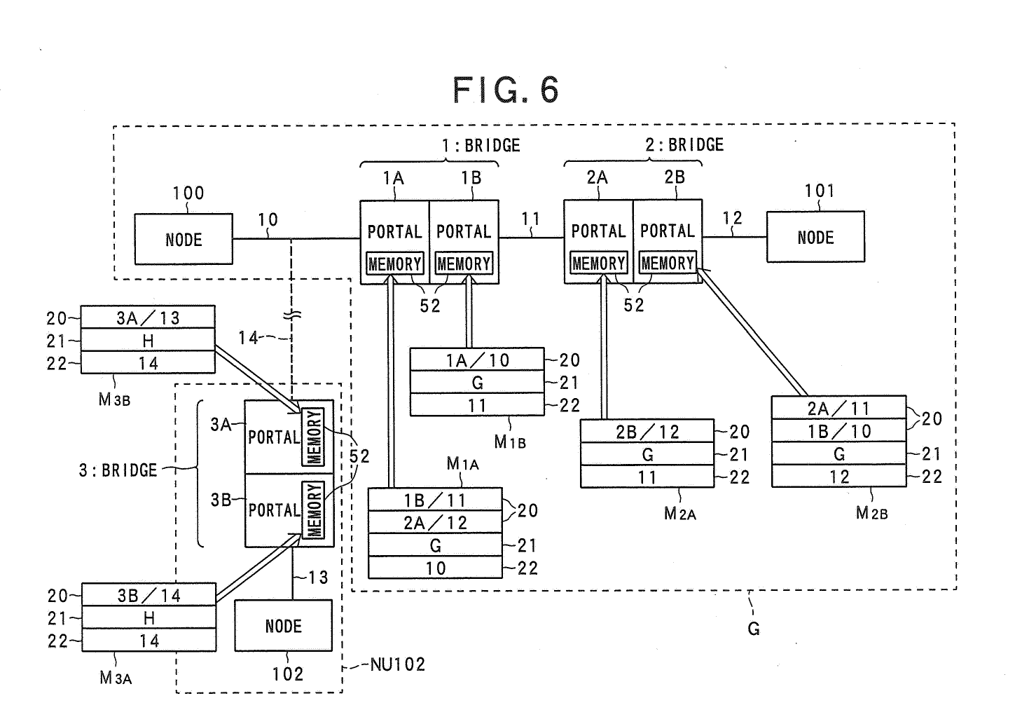

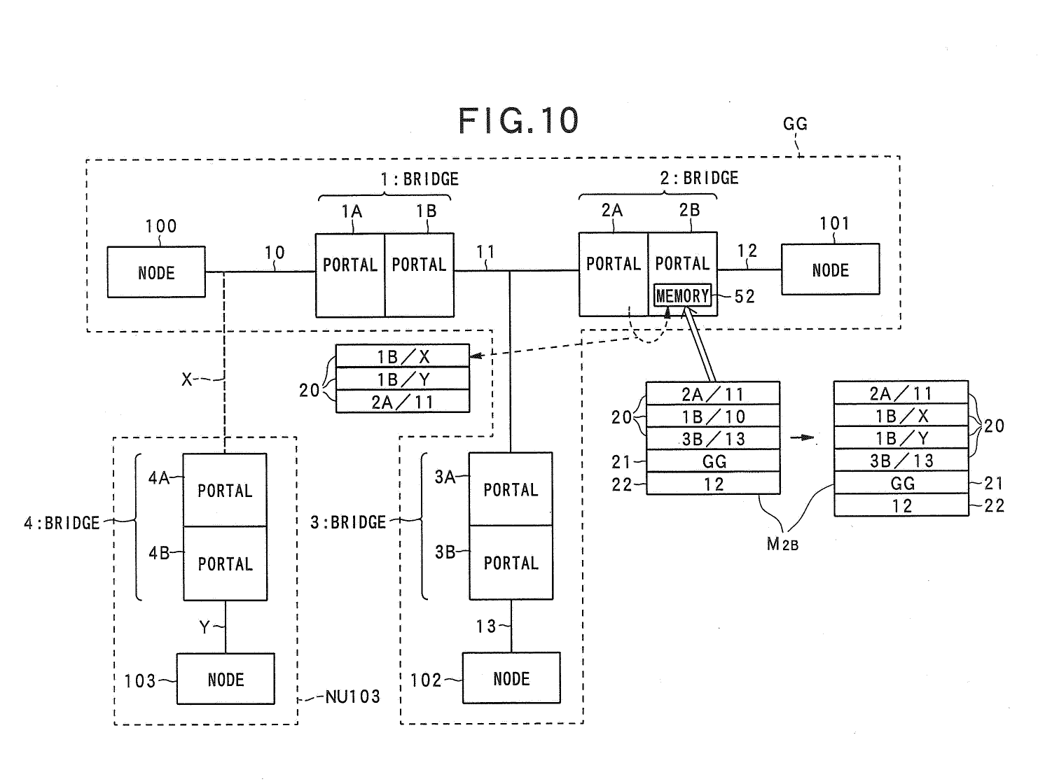

FIG. 1 is a block diagram showing the construction of a network of an embodiment of the invention, FIG. 2 is a block diagram showing the detailed construction of a portal that is included in the network, FIG. 3 and FIG. 4 are drawings showing the contents of the route maps inside the portals for the state in which three network units are connected, FIGS. 5A and 5B are flowcharts showing the connection control process of this embodiment, FIG. 6 to FIG. 9 are drawings showing examples of the transition of the route map in the execution of the connection control process, and FIG. 10 is a drawing explaining the effect when the connection control process is executed.

As shown in FIG. 1, the network N of this embodiment is formed by connecting two network units NU100 and NU101 by way of a bridge 1.

Also, the network unit NU100 is formed by a plurality of nodes 100, 100B, 100C, 100D, 100E, . . . , to which node ID information that is unique on a global scale is given to each node, and which are serially connected by busses 10 having common bus ID information. Also, network NU100 is connected to network NU101 by portal 1A that is similarly connected by a bus 10. (In the explanation below, node 100 will be used representatively for nodes 100, 100B, 100C, 100D, 100E, etc.)

On the other hand, network unit NU101 is similarly formed by a plurality of nodes 101, 101B, 101C, 101D, 101E, . . . , to which node ID information that is unique on a global scale is given to each node, and which are serially connected by busses 10 having common bus ID information. Also, network NU101 is connected to network NU100 by portal 1B that is similarly connected by a bus 10. (In the explanation below, node 101 will be used representatively for nodes 101, 101B, 101C, 101D, 101E, etc.)

Furthermore, portal 1A and portal 1B are connected by a connection method in bridge 1 that complies with a standard that differs from the IEEE 1394 standard.

Next, the detailed construction of the portals 1A and 1B of the invention will be explained using FIG. 2. Portals 1A and 1B both have the same construction, so in the explanation below, only the detailed construction of portal 1A will be explained.

As shown in FIG. 2, portal 1A of this embodiment comprises: an interface 50 that is connected to the bus 10; a control unit 51 as a bus ID information generation device, update device, detection device and deletion device; and a memory 52 as a memory device.

In this construction, the control unit 51 executes the connection control process of the embodiment as will be described later.

Also, the memory 52 stores information of the route map described above, and node ID information that indicates the portal A which is one of the nodes of the network unit NU100. Moreover, this information is output as a memory signal Sm according to a request signal from the control unit 51. In the explanation below, generally, in order to distinguish node ID information that indicates nodes other than portals, node ID information that indicates a portal is simply called portal ID information.

Furthermore, by exchanging control information Sc with the interface 50, the control unit 51 executes the connection control process as will be described later.

Also, based on control information Sc from the control unit 51, the interface 50 outputs necessary information to the bus 10, and exchanges necessary information with the portal 1B (and network unit NU101) by way of the connection line PP that connects portal 1B and portal 1A.

Next, a plurality of networks N are connected together by way of the bridge 1 to form a single network group G, and the route maps that are stored in the portals of this embodiment after the network group G is formed will be explained in detail using the example shown in FIG. 3. In the network group G of the example shown in FIG. 3, the network unit NU100 that comprises node 100, bus 10 and portal 1A, and the network unit NU102 that comprises bus 11, portal 1B and portal 2B are connected serially by the bridge 1. Also, the network unit NU101 that comprises node 101, bus 12 and portal 2B, and network unit NU102 described above are connected serially by the bridge 2.

In the construction described above, the value of the bus ID information that indicates bus 10 is taken to be ‘10’, the value of the bus ID information that indicates bus 11 is taken to be ‘11’, and the value of the bus ID information that indicates bus 12 is taken to be ‘12’. Moreover, the value of the portal ID information that indicates portal 1A is taken to be ‘1A’, the value of the portal ID information that indicates portal 1B is taken to be ‘1B’, and the value of the bus ID information that indicates portal ID information 2B is taken to be ‘2B’. Furthermore, the value of the network ID information that indicates network group G is taken to be ‘G’.

With the conditions described above, transfer-capable bus ID information that indicates other busses (for example bus 11 and bus 12 in FIG. 3) by which it is possible to transfer the information that was transferred by way of bus 10 by way of portal 1A and portal B, transmission source portal ID information that indicates another portal that generated bus ID information and transmitted it to portal 1A, route map information 20 that is created and included in each portal, network ID information 21 that indicates the network or network group (network group G in the case of FIG. 3) to which portal A belongs, and local bus ID information 22 that is bus ID information that indicates the local bus that is the bus connected directly to the portal (in other words, without passing through another portal such as portal 1B) are stored in the memory 52 (see FIG. 2) of portal 1A shown in FIG. 3 as route map M_{1A}. Also, the route maps M_{1B}, M_{2A} and M_{2B} that are stored in the respective memories 52 of the other portals 1B, 2A and 2B other than portal 1A also basically include the aforementioned route map information 20, network ID information 21 and local bus ID information 22, even though there may be differences in the number of route map information 20.

Here, the transfer-capable portal ID information and transmission source portal ID information of one item of route map information 20 will be explained in detail.

First, as a premise to the explanation, it is considered that in the network group G that is shown in FIG. 3, for example, certain specified information is sent from node 100 to node 101.

In this case, node ID information that indicates that the transfer destination is node 101, and bus ID information that indicates that bus 12 is the local bus directly connected to node 101 are added to that specified information as destination information. Also, specified information that is output from the node 100 together with that kind of destination information passes through the portals (portals 1B, 2A and 2B in FIG. 3) in which the route maps M are stored and that contain the bus ID information included in that destination information, and finally arrives at the desired node 101.

As shown in FIG. 4, a bridge 3 (portal 3A that corresponds to portal 3B) that includes a third portal 3B other than the portals 1B and 2A shown in FIG. 3 is connected to the bus 11 shown in FIG. 3, and bus 13 and node 102 are newly connected by way of portal 3A. In this case, the portals 3A and 3B in the bridge 3 have the same construction and function as the bridges 1 and 2 described above, and the contents of the route maps M_{3B} and M_{3A} that are respectively stored in the portals 3A and 3B are as shown in FIG. 4.

Also, as shown in FIG. 4, bus ID information that indicates that bus 12 is a local bus for node 101 is not included in the route map M_{3B} that is stored inside that portal 3B. Therefore, when portal 3B that received the specified information that is output from portal 1B references the route map M_{3B} inside the portal 3B to determine whether or not to transfer the specified information to portal 3A that forms bridge 3 together with portal 3B, the bus ID information that is included in the destination information does not exist in the route map M_{3B}, so that specified information is not transferred to portal 3A. With this kind of construction, the specified information is able to reach the destination of node 101 over the shortest route without having to be transferred over unnecessary busses. In addition to this, the specified information is not transferred to any of the other portals that are connected to this third portal, so it is possible to reduce the amount of information that is transmitted over the local busses of the other portals.

Returning to the example shown in FIG. 3 from the construction described above, the route map M_{1A} inside portal 1A contains two items of route map information 20, network ID information whose value is ‘G’, and local bus information 22 whose value is ‘10’, where the values of each of the items of route map information 20 are ‘1B/11’ and ‘2A/12’, respectively. Here, the route map information 20 having the value ‘1B/11’ includes bus ID information that indicates the local bus of the other portal 1B that forms bridge 1 together with portal 1A, and indicates that the value of the bus ID information that indicates the local bus of portal 1B that is sent from portal 1B is ‘11’. Similarly, the route map information 20 having the value ‘2A/12’ includes bus ID information (the value of which is ‘12’ in FIG. 3 or FIG. 4) that indicates a bus by which portal 2A is capable of transferring information (a bus other than the local bus of portal 2A over which information can be transferred by way of portal 2A), and includes the value of the bus ID information that is included in the route map information 20 that is sent from the other portal 2A that exists on bus 11, which is the local bus of portal 1B.

When there is a plurality of busses that are capable of transferring information by way of portal 2A, the number of items of route map information having the value ‘2A/OO’ (‘OO’ is the value of the bus ID information that indicates a bus that is capable of transferring that information) that are included in the route map M_{1A} equals the number of busses (the same is true below).

Another portal like portal 1B described above that forms a bridge (for example bridge 1) together with a portal (for example portal 1A) is called a ‘coportal’ of that portal. In other words, of the two portals that form a bridge, the other portal as seen from one portal is a coportal, and similarly the one portal as seen from the other portal is a coportal.

Similarly, the route map M_{1B} inside portal 1B contains one item of route map information 20, network ID information having the value ‘G’, and local bus information 22 having the value ‘11’, where the value of the route map information 20 is ‘1A/10’. Here, the route map information 20 having the value ‘1A/10’ includes bus ID information that indicates the local bus of portal 1A, which is a coportal of portal 1B, and indicates that the value of the bus ID information that indicates the local bus of portal 1A that was sent from portal 1A is ‘10’.

Also, the route map M_{2A} inside portal 2A contains one item of route map information 20, network ID information 21 having the value ‘G’, and local bus information 22 having the value ‘11’, where the value of the route map information 20 is ‘2B/12’. Here, the route map information 20 having the value ‘2B/12’ includes bus ID information that indicates the local bus of the portal 2B, which is a coportal of portal 2A, and indicates that the value of the bus ID information that indicates the local bus of portal 2B that was sent from the portal 2B is ‘12’.

Finally, the route map M_{2B} inside the portal 2b contains two items of route map information 20, network ID information 21 having the value ‘G’, and local bus information 22 having the value ‘12’, where the values of the items of route map information 20 are ‘2A/11’ and ‘1B/10’, respectively. Here, the route map information 20 having the value ‘2A/11’ includes bus ID information that indicates the local bus of portal 2A, which is a coportal of portal 2B, and indicates that the value of the bus ID information that indicates the local bus of portal 2A that is sent from portal 2A is ‘11’. Similarly, route map information 20 having the value ‘1B/10’ includes bus ID information (the value of which is ‘10’ in FIG. 3 or FIG. 4) that indicates a bus over which the portal 1B can transfer information (a bus that is other than the local bus of the portal 1B, and over which information can be transferred by way of portal 1B), and includes the value of the bus ID information that is included in the route map information that is sent from the other portal 1B that exists on the bus 11, which is the local bus of portal 2A.

In this way each portal has bus ID information, which indicates a bus over which information can be transferred by way of a portal that is directly connected to that portal, as a route map M for that portal, so by reducing the transmission of unneeded information, it is possible for necessary information to reach the destination more efficiently and quickly.

Next, the connection control process that is executed by the control units 51 in the portal 1A to 2B for forming route maps M inside the portals 1A to 2B as shown in FIG. 3 or FIG. 4 after the network group G has been formed, will be explained in detail using the flowcharts shown in FIGS. 5A and 5B.

The flowcharts shown in FIGS. 5A and 5B are flowcharts that show the process when another network or another network unit is physically connected to an existing network or network unit by way of a bridge inside that network or network unit, where a bus reset occurs in the network group that is formed after that connection is made, after which the route map M inside each of the portals is updated. FIG. 5A is a flowchart showing the process for detecting the bus reset that occurred when a bus reset occurred inside the network group that was formed after connection, and FIG. 5B is a flowchart that shows in detail the update process that is executed after that bus reset.

First, the process for detecting a bus reset that occurs when a bus reset occurred in a network group that was newly formed will be explained using FIG. 5A.

When another network or network unit is connected to a network or network unit to form a new network group, the control units 51 in each of the portals that are included in that network group monitor whether or not there is a notification indicating that a bus reset occurred as a result of that connection (step S1).

Also, when it is confirmed that a bus reset occurred (step S1: YES), update of the route maps M inside the memories 52 that are included in the portals, as well as in the control units 51, begins (step S2). More specifically, first, portal ID information that indicates all of the other portals that are directly connected to the local bus that is directly connected to the portal, and network ID information 21 that indicates the network (or network unit) in which the other portals are included is obtained from all of the other portals (steps S3, S4).

Next, based on the obtained network ID information, the existence of a loop condition in the new network group is confirmed using the same method as the method of confirming the existence of a loop condition in the new network group used in the conventional IEEE 1394.1 standard.

Also, when it is confirmed that a loop condition does not exist in the network group (step S5: NO), then next, based on each portal ID information that was acquired in step S3, each portal generates new bus ID information that indicates the bus that was newly formed when that network group was formed (step S6).

Here, the process executed in step S6 for generating the bus ID information can specifically be any kind of processing algorithm as long as it clearly sets new bus ID information based on the portal ID information acquired in step 3, and is executed based on a processing algorithm that is unified for all of the portals inside the network group.

More specifically, the maximum value of the portal ID information acquired in step 3 that indicates the portals on the local bus can be used as is as the value of the bus ID information, or similarly, the minimum value of the portal ID information can be used as is as the value of that bus ID information. The method for setting other bus ID information will be described later.

After bus ID information that indicates the newly formed bus that was formed by the method described above has been set, then each portal uses the portal ID information that was acquired in step S3 and generates network ID information that indicates the newly formed network group using the same method as used in step S6 (step S7), after which, sends an update message to all of the other portals on the local bus that the portal is directly connected to for updating the contents of the route maps that are stored in each of the respective portals (step S8). Here, the update message that is sent in the processing of step S8 contains transfer-capable bus ID information that indicates busses over which it is possible for the portal that sent the update message to transfer information, and network ID information that indicates the network group in which the portal is included.

Also, after sending the necessary update message to the other portals (step S8), the portal determines whether or not the power to that portal is turned OFF (step S9), ad when the power is turned OFF (step S9: YES) that portal ends the processing shown in FIG. 5, however, when the power continues to be ON (step S9: NO), the portal moves to the waiting state (in other words, the bus reset wait state) and waits for the next message to be sent (step S10), then returns to step S1 and repeats the process described above.

On the other hand, in the judgment of step S5, when there is a loop condition inside the new network group (step S5: YES), by performing a message with the other portals included in the new network group, the portal performs a deletion process for deleting the loop condition by the same method as regulated by the conventional IEEE 1394.1 standard (step S25), and together with generating a bus reset (bus reset for updating each of the route maps) to accompany that loop deletion process, sends a notification of that to the other portals and nodes (step S26), then moves to step S10 described above.

Next, the update process that is executed after a bus reset is generated in a newly formed network group will be explained using FIG. 5B.

As shown in FIG. 5B, in the update process for updating each of the route maps M after bus reset, first, the portal checks whether or not an update message for updating the route map M was sent (step S11), and when the update message was sent (step S11: YES), the portal checks whether or not that update message was sent from another portal that forms a bridge with the portal (step S12).

Here, the contents of an update message that is sent from one portal to the coportal will be explained in detail. That update message contains the aforementioned route map information 20, network ID information that indicates the network (or network group) in which the portal is included, and local bus ID information 22 that indicates the local bus to which the portal is directly connected. Here, the route map information 20 is information that is sent for each of the other portals that are directly connected to the local bus to which the portal itself is directly connected, and more specifically, it comprises transfer-capable bus ID information for the other portals, and portal ID information that indicates each of the other portals.

In step S12, when the update message that was sent was not sent from a coportal (step S12: NO), then next the portal uses the method described below to determine whether or not there is a loop condition in the new network group (step S13).

To describe the method of detecting a loop condition that is executed in step S13 more specifically, first, the portal compares the bus ID information that is included in the received (step S11: YES) update message and the transfer-capable bus ID information that is given in the route map M that is stored inside that portal, and determines whether or not bus ID information having the same value is included in that information. When bus ID information having the same value is included in both, the bus that is indicated by the bus ID information having the same value exists on both connection terminal of the bridge that is formed by that portal and the corresponding coportal, so there is a possibility that a loop condition is included in the current network group. This is because with the method for setting new bus ID information of this invention (step S6 described above), it is not possible for two or more busses indicated by the same bus ID information to exist in that network group. From this, when it is determined that there is a possibility that a loop condition exists, by exchanging information with the other portal having as a local bus the bus that is indicated by that redundant bus ID information, that portal checks for certain whether or not the bus indicated by the same bus ID information exists at both connection terminals. When the bus indicated by the same bus ID information does exist, it is possible to determine that a loop condition occurs at a location inside the network group. On the other hand, when the bus indicated by the same bus ID information does not exist at both connection terminals, it is possible to determine that a loop condition does not exist in the network group.

Moreover, when a loop condition is actually detected (step S13: YES), the portal deletes that loop condition by the same process as in step S25 described above, and together with generating a bus reset to accompany that loop deletion process (bus reset for each rout map M update), sends a notification of that to the other portals and nodes (step S15), then moves to the processing of step S20 described later.

On the other hand, when a loop condition is not detected in step S13 (step S13: NO), the portal uses the network ID information 21 included in the update message to update the network ID information 21 that indicates that portal itself (step S16), then generates an update message for the coportal on the local bus to which bus ID information that indicates the newly formed bus is added and sends it to that coportal (step S17), after which it moves to the processing of step S20 to be described later.

On the other hand, in step S12, when the sent update message is from the corresponding coportal (step S12: YES), the portal uses the contents to update the route map information 20 and network ID information 21 in the route map M of that portal itself (step S18), then sends a notification message indicating that the information was updated to the other portals that are directly connected to the local bus to which that portal is connected (step S19). Also, the portal checks whether or not the power to the portal is turned OFF (step S20), and when the power is turned OFF (step S20: YES), that portal ends the processing shown in FIG. 5, however, when the power continues to be turn ON (step S20: NO), the portal moves to the update message wait state to wait for the update message to be sent from another portal (step S21), then returns to step S11 and repeats the process described above.

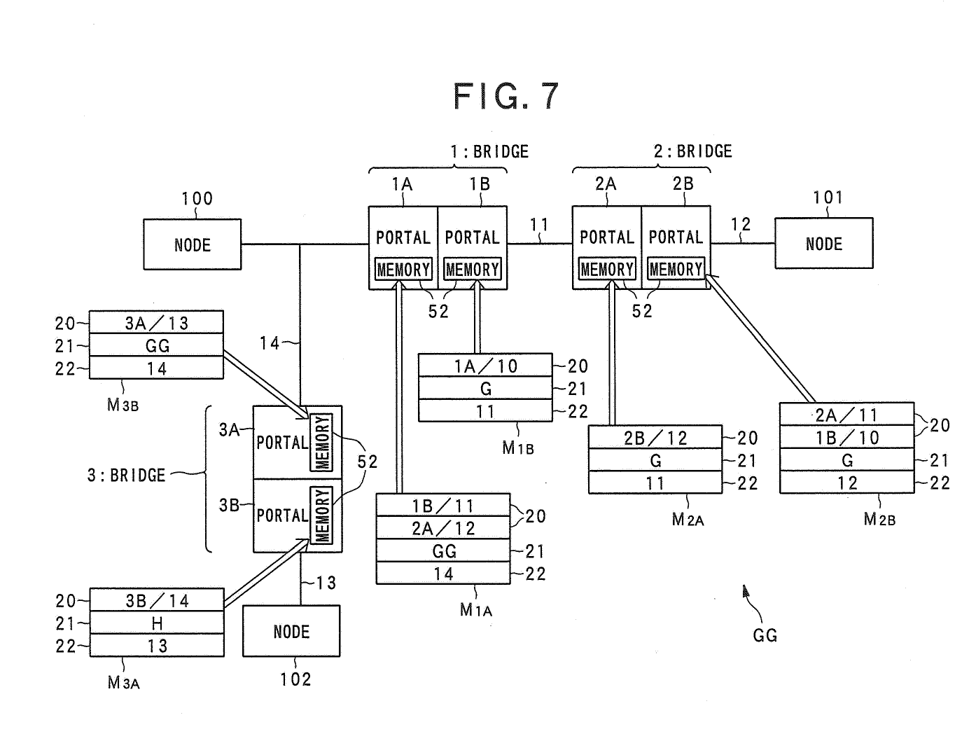

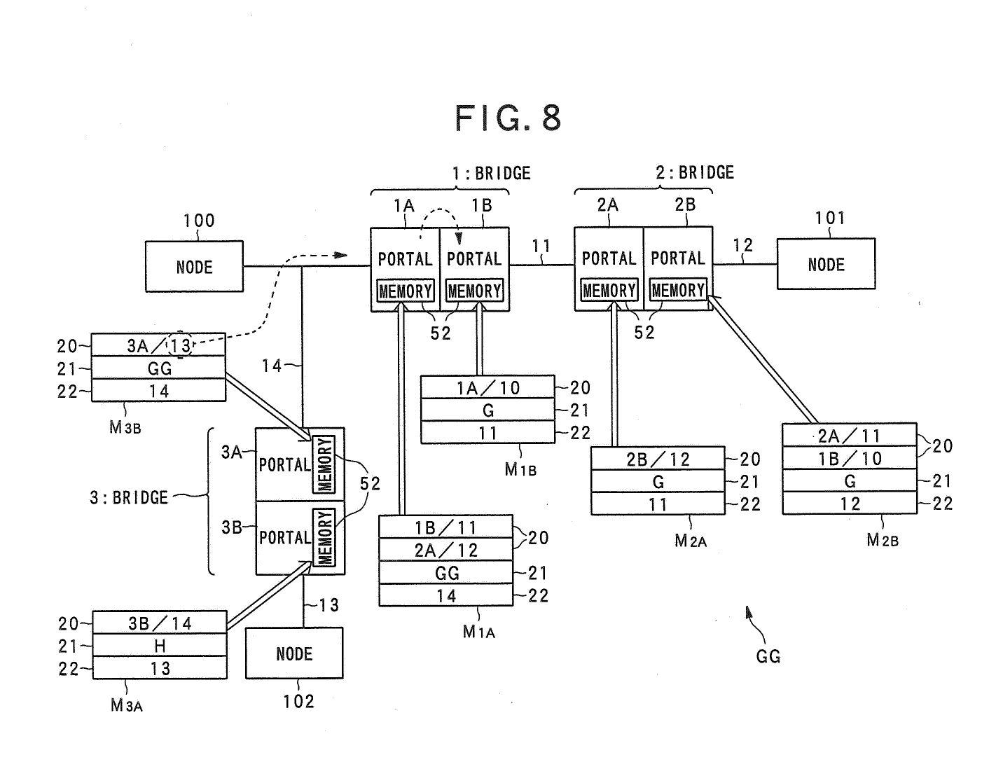

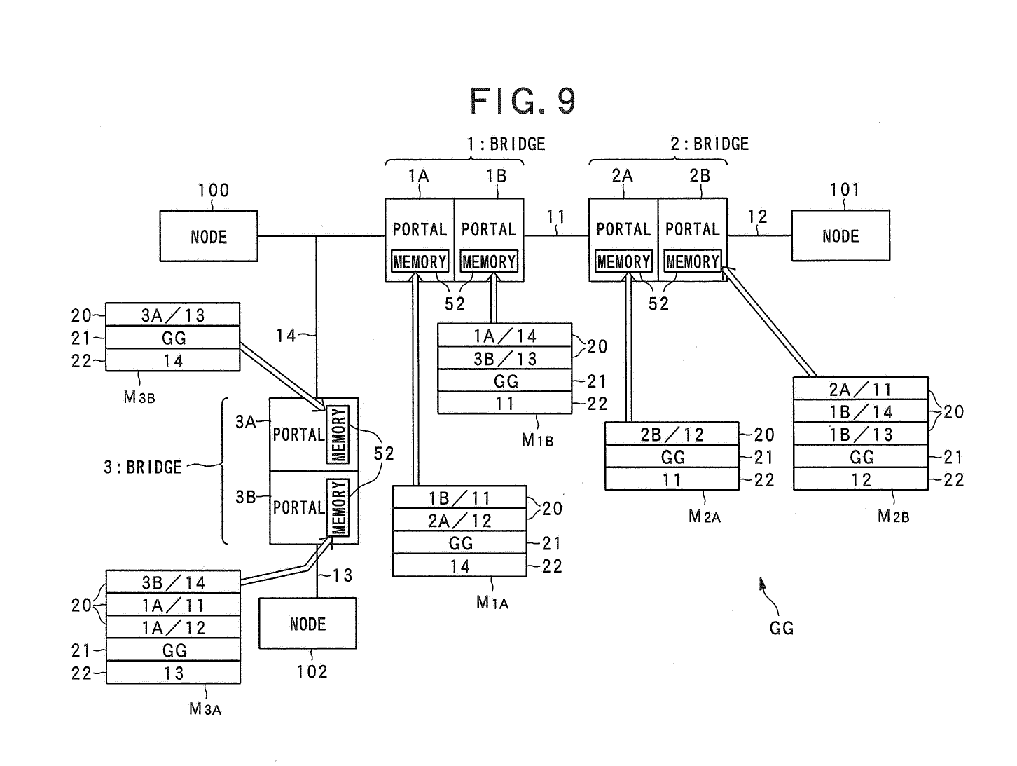

Next, the connection control process of this embodiment that was explained using FIG. 5 will be explained in more detail using the specific example shown in FIG. 6 to FIG. 9. FIG. 6 to FIG. 9 are drawings showing an example of the updated state of the route maps M that are stored in each of the portals over time as a result of execution of the connection control process of this embodiment, and with the timing of when a new network is connected to an existing network using a bridge as a reference, an example of the update state as the route maps M are updated is shown over time in the order of FIG. 6→FIG. 7→FIG. 8→FIG. 9. Furthermore, the example shown in FIG. 6 to FIG. 9 is an example of the case in which by adding a new bridge to the bus 10 that is included in the network unit NU100 inside the network group G, whose construction has already been explained using FIG. 3, a new network (or network unit) is additionally connected to the network group G to form a new network group GG.

In other words, FIG. 6 shows an example in which, by connecting bridge 3 comprising portals 3A and 3B (the values of the portal ID information are taken to be ‘3A’ and ‘3B’, respectively) to the bus 10 inside the network group G that was explained using FIG. 3, a bus 13 (the value of the bus ID information before connection is taken to be ‘13’ and node 102 are newly connected. In the portal 3B that is later connected to the network group G, there is a local bus even before connection, and the value of the bus ID information that indicates the local bus of portal 3B after connection will be taken to be ‘14’. Also, the value of the network unit ID information that indicates the network unit NU102 that comprises bridge 3, busses 13 and 14, and node 102 is taken to be ‘H’.

In FIG. 6 to FIG. 9, in order to simplify the explanation, bridge 3 is shown to be connected by connecting a new bus to bus 10 in a ‘T’ shape, however, the actual physical connection is achieved by two buses, the bus that connects node 100 and portal 3B, and the bus that connects portal 3B and portal 1A (the shape of the physical connection is a ‘V’ shape), or by two busses, a bus that connects node 100 and portal 1A, and a bus that connects portal 3B and portal 1A (the shape of the physical connection is a ‘┐’ shape), or two busses, a bus that connect node 100 and portal 1A, and a bus that connects portal 3B and portal 1A (the shape of the physical connection is a ‘┌’ shape).

Also, as shown in FIG. 6, the contents of the route maps M_{1A}, M_{1B}, M_{2A} and M_{2B} up until portal 3B is connected are the same as the respective contents explained using FIG. 3. In addition to this, in the route map M_{3B} that is stored in the memory 52 inside the portal 3B to be newly connected, the value of the portal ID information for portal 3A, which is a coportal with respect to portal 3B, is ‘3A’, and the value of the bus ID information that indicates that bus 13 is the local bus is ‘13’, so the value of the transfer-capable bus ID information is ‘13’, and the route map M_{3B} comprises route map information 20, whose value for the transmission source portal ID information is ‘3A’, value for the network ID information is ‘H’ and value for the local bus ID information 22 is ‘14’.

Furthermore, in the case of portal 3A, in the route map M_{3A} that is stored in the memory 52 inside the portal 3A, the value of the portal ID information for portal 3B, which is a coportal with respect to portal 3A, is ‘3B’, and the value of the bus ID information that indicates that bus 14 is the local bus is ‘14’, so the value of the transfer-capable bus ID information is ‘14’, and the route map M_{3A} comprises route map information 20, whose value for the transmission source portal ID information is ‘3B’, value for the network ID information is ‘H’, and value of the local bus ID information 22 is ‘13’.

With the conditions described above as a premise, the case of connecting a bridge 3 that includes portal 3B to the network group G to form a new network group GG will be explained using FIG. 5 to FIG. 9.

First, the network unit that comprises bridge 3, busses 13 and 14 and node 102 is physically connected to bus 10, and just before the occurrence of the bus reset caused by that connection, the contents of the route maps M_{1A}, M_{1B}, M_{2A}, M_{2B}, M_{3A} and M_{3B} are as shown in FIG. 6.

Also, after the bus reset caused by the connection occurs (see steps S1 and S2 in FIG. 5), then as shown in FIG. 7, the values of portal 1A (having a portal ID information value of ‘1A’) and portal 3B (having a portal ID information value of ‘3B’) that exist on the newly added bus (the corresponding bus ID information has not yet been defined (shown by the dashed line in FIG. 6)) acquire the network ID information that indicates the network (or network unit) that includes portal ID information that indicates all of the portals (portal 1A and portal 3B in this case) on the added bus (see steps S3 and S4 in FIG. 5). The control units 51 inside portal 1A and portal 3B acquires the portal ID information having the value ‘1A’, and the network ID information having the value ‘G’, portal ID information having the value ‘3B’ and the network ID information having the value ‘H’, respectively.

Next, based on the acquired network ID information, the control units 51 inside portal 1A and portal 3B detect whether there is a loop condition (see step S5 in FIG. 5).

Here, in the case shown in FIG. 6 and FIG. 7, a loop condition does not exist (see FIG. 5, step S5: NO), so next, the control units 51 inside portal 1A and portal 3B use the acquired portal ID information, connects bus 10 and bus 14 as shown in FIG. 6, and sets the value of the bus ID information that indicates the newly created (or in other the newly created bus 14 shown in FIG. 7) (see step S6 in FIG. 5). The process for setting the value of this bus ID information can be performed by the control units 51 inside portal 1A and portal 3B, or can be performed by just one of the portals on the new bus 14. Next, the control units 51 inside portal 1A and portal 3B set the value for the new network ID information using the same method (see step S7 in FIG. 5), and then use the newly set bus ID information and network ID information to update the local bus ID information and network ID information for portal 1A and portal 3B (see step S8 in FIG. 5).

More specifically, as shown in FIG. 7, based on the portal ID information that indicates portal 1A, and the portal ID information that indicates portal 3B, the value ‘3B’ of the portal ID information that indicates portal 3B is used to temporarily set the bus ID information that indicates the new bus 14 as ‘14’. By doing this, the control units 51 of portal 1A and portal 3B update the values of their own respective local bus ID information to ‘14’.

Similar to this, based on the network ID information that corresponds to portal 1A and the network ID information that corresponds to portal 3B, the value ‘H’ of the network ID information that corresponds to portal 3B is used to temporarily set the new network ID information to ‘GG’. By doing this, the control units 51 of portal 1A and portal 3B update the network ID information 21 that indicates themselves to the value ‘GG’.

Next, portal 1A and portal 3B on the new bus 14 (the value of the bus ID information is ‘14’) send update messages that contain the route map information 20 that they currently store to all of the portals on the bus 14, which is the local bus (see step S8 in FIG. 5).

More specifically, as shown in FIG. 8 for example, portal 1A receives the transfer-capable bus ID information (the value is ‘13’) from portal 3B that is stored in the route map information 20 of portal 3B.

In the explanation below, processing is explained for just portal 1A, however, the same processing is performed at the same time by portal 3B.

Next, after receiving the update message, portal 1A confirms that no loop condition exists inside the new bus structure itself (step S13 in FIG. 5), then adds the local bus ID information 22 (the value is ‘14’ that indicates that bus 14 is the new local bus to that received update message, and transfers the update message to portal 1B, which is a coportal (see the dot-dash line in FIG. 8 and step S17 in FIG. 5). In this process, when a loop condition is found in the new bus structure, this is deleted by the method explained in step S14 of FIG. 5.

Also, in FIG. 8, the update message that is transferred from portal 1A to portal 1B specifically comprises: route map information 20 that includes the transfer-capable bus ID information of portal 3B (the value is ‘13’) and the transmission source portal ID information for it (the value is ‘3B’); local bus ID information 22 (the value is ‘14’) that indicates bus 14, which is the new local bus of portal 1A, and the transmission source portal information for it (the value is 1A); and network ID information 21 that indicates the network to which portal 1A currently belongs (the value is ‘GG’).

Next, after the update message having these contents has been transferred to portal 1B, portal 1B uses that transferred update message to update the route map M_{1B} that is currently stored in its memory 52, and transfers the new update message to all of the other portals (portal 2A in the case shown in FIG. 6 to FIG. 9) that are connected to bus 11, which is its local bus (see steps S18 and S19 in FIG. 5).

To explain these processes in more detail, first, as shown in FIG. 9, of the route map information 20 stored up until now inside its memory 52, portal 1B updates the information whose value was ‘1A/10’ to the value ‘1A/14’ based on the update message ‘1A/14’ from portal 1A.

Next, based on route map information 20 whose value is ‘3B/13’ and that is included in the update message from portal 1A, portal 1B adds route map information 20 whose value is ‘3B/13’ to its route map M_{1B} as new route map information 20 that did not exist before.

Furthermore, based on the network ID information whose value is ‘GG’ and that is included in the update message from portal 1A, portal 1B updates the network ID information 21 up to that point (the value was ‘G’ to the value ‘GG’.

Next, after update of its route map M_{1B}, the control unit 51 of portal 1B transfers the transfer-capable bus ID information for the bus in portal 1B that has newly become capable of transfer, and the network ID information to portal 2A (the value of that portal ID information is ‘2A’) that is directly connected to bus 11, which is the local bus.

More specifically, as the information that is transferred, two items of transfer-capable ID information having the values ‘13’ and ‘14’ is transferred as the transfer-capable bus ID information for the bus in portal 1B that has newly become capable of transfer, and network ID information 21 whose value is ‘GG’ is transferred as the new network ID information 21.

Also, the portal 2A there received the transferred information checks itself whether or not there is a loop condition on the new bus structure (see step S13 in FIG. 5), then adds the local bus ID information 22 for portal 2A to the update message that was received from portal 1B, and transfers the update message to portal 2B, which is a coportal (see step S17 in FIG. 5).

In explaining this process in more detail, first, the portal 2A checks whether or not there is a loop condition (see step S13), and after updating the value of the corresponding network ID information 21, transfers the following information to portal 2B as an update message.

In other words, route map information 20 that includes transfer-capable bus ID information for portal 1B (two items of route map information 20 having the values ‘1/B/14’ and ‘1B/13’), route map information 20 that includes local bus ID information 22 for portal 2A (having the value ‘2A/11’), and new network ID information 21 (having the value ‘GG’) are transferred from portal 2A to portal 2B as an update message.

Also, the portal 2B receives this update message, and based on the information, updates its own route map M_{2B} as follows (see step S18 in FIG. 5).

That is, portal 2B uses the route map information 20 having the value ‘2A/11’ that was included in the update message to update the route map information 20 that it has stored up to this point having a value of ‘2A/11’ to a value ‘2A/11’, uses the route map information 20 having the value ‘1B/10’ that was included in the update message to update the route map information 20 having the value ‘1B/10’ that it stored up to that point to a value ‘1B/14’, and uses the network ID information 21 having the value ‘GG’ that was included in the update message to update the network ID information 21 having the value ‘G’ that it stored up to that point to a value of ‘GG’.

After update of all of the route maps M is completed by repeating the update process described above for a series of route maps M, in the state of the route maps M_{1A}, M_{1B}, M_{2A}, M_{2B}, M_{3A} and M_{3B} shown in FIG. 9, each route map M is stored in a respective memory 52.

As was explained above, with the connection control process of this embodiment, bus ID information that corresponds to the bus 14 that is included in a newly formed network group GG is generated based on any one of the portal ID information that corresponds to a portal that is included in that network group GG, and the route maps M that correspond to each of the portals are updated using that generated bus ID information, so the bus ID information itself becomes unique inside that network group GG, redundancy of bus ID information that occurs when connecting a pair of networks can be deleted and the pair of networks can be connected smoothly.

Also, bus ID information for identifying bus 14 is generated based on the portal ID information (the value is ‘3B’) corresponding to portal 3B that is directly connected to that bus 14 to be identified, unique bus ID information can be easily and efficiently assigned in the new network group GG for the bus 14 inside that network group GG.

Furthermore, depending on whether or not bus ID information having the same contents is included in the route map M, a loop condition is detected and removed after the network group GG is formed, so a method is possible that is capable of accurately detecting a forbidden loop condition.

Moreover, of the portal ID information that corresponds to any one of the portals included in the network group GG, by using portal ID information having the maximum value to generate new bus ID information, for example, bus ID information can be generated and the route maps M can be updated by a simple method.

Also, the route maps M that correspond to the portals comprise route map information 20 that contains transfer-capable bus ID information and transmission source portal ID information, so the update process for updating the route maps M when forming the network group GG can be simplified, and a route map M is updated by adding, changing or deleting necessary route map information 20 when updating the route map M during network connection, so even though a bus reset may occur on one bus, the route map M can be updated without a bus reset occurring on another bus, and it is possible to prevent the network group GG from becoming unstable due to the propagation of a bus reset.

Here, the effect of having the route map information 20 described above comprise of transfer-capable bus ID information and transmission source portal ID information, and the reason for including transmission source portal ID information in one item of route map information 20 and not just transfer-capable bus ID information will be explained using FIG. 10.

The reason for including transmission source portal ID information is that generally speaking, when there is no transmission source portal ID information, the update process for updating each route map M becomes complicated and time consuming.

In other words, in the connection control process of this embodiment, one item of route map information 20 comprises both transfer-capable bus ID information for the portal in which the route map M that includes the route map information 20 is stored, and transmission source portal ID information for that transfer-capable bus ID information, however, the minimum necessary information as route map information 20 for executing the connection control process of this embodiment is just the transfer-capable bus ID information. However, by constructing the route map information 20 with just that transfer-capable bus ID information, it becomes complicated to perform the update process of this embodiment of updating the route map M of the portal.

In other words, in the case where there is no transmission source portal ID information, for example, when portal 2A shown in FIG. 10 receives a message from portal 1B for updating the route map, it can be seen that contents of a bus that is connected before portal 1B as seen from portal 2A changed. However, for information that indicates a bus that is connected before the other portal 3B that is connected to bus 11, which is the local bus of portal 1B, as seen from portal 2A, it is not possible to determine whether or not the contents, which should be confirmed by portal 2A itself by way of portal 3B, have changed. That is, for portal 2A, if an update message is not transferred to portal 2B after first checking information that indicates the busses that are connected before portal 3B, it will not be possible for portal 2B to accurately update the route map M_{2B} that corresponds to the network group.

Therefore, by also including transmission source portal ID information as a pair, and not using just transfer-capable bus ID information as route map information 20, it is possible to update the bus ID information according to each transmission source portal ID information.

This point will be explained in more detail using FIG. 10.

As shown in FIG. 10, there is a network group GG that is formed by connecting a new network unit to the network group G shown in the example of FIG. 3, and the connection control process of this embodiment starts when connecting another network unit NU103 (includes a bridge comprising portal 4A and portal 4B (the values of the bus ID information that indicate the respective local busses before connection to the network group GG are ‘X’ and ‘Y’, respectively), bus Y and node 103) to this network group GG. Also, the values of the respective portal ID information that indicate portals 1A, 1B, 2A and 2B, are ‘1A’, ‘1B’, ‘2A’ and ‘2B’, respectively, and the values of the portal ID information that indicate already connected portals 3A and 3B are ‘3A’ and ‘3B’, respectively, and furthermore, the values of the bus ID information that indicate busses 10 to 13, are ‘10’, ‘11’, ‘12’ and ‘13’, respectively. Moreover, the value of the network ID information 21 that indicates the network group GG is ‘GG’.

In this case, when the network unit NU103 is connected to the network group GG, as seen from portal 1B there are two new busses in the place of bus 10 over which information can be transferred by way of portal 1A, and supposing that the values of the bus ID information that indicate the respective busses are ‘X’ and ‘Y’, respectively, portal 1B transfers the new message that was transferred from portal 1A to portal 2B and portal 3A by way of portal 2A and portal 3B, and executes the connection control process that was described above.

Focusing attention on portal 2B of the portals shown in FIG. 10, portal 2B receives an update message from portal 2A having the value shown below. That is portal 2B receives an update message that includes three items of route map information 20 having the values ‘1B/X’, ‘1B/Y’ and ‘2A/11’ as route map information.

Also, from this, portal 2B updates the two items of route map information inside the route map M_{2B} that it has stored up to this point (having the values ‘2A/11’ and ‘1B/10’) to three items of route map information 20 having new values (‘2A/11’ and ‘1B/X’), and adds one new item of route map information 20 having the value ‘1B/Y’. The route map information 20 having the value ‘3B/13’ is not updated.

Here, supposing that the route information 20 comprised only transfer-capable bus ID information, then in portal 2B, two items of new route map information 20 (having the values ‘X’ and ‘Y’) are added to the three items of route map information 20 (having the values ‘11’, ‘10’ and ‘13’) that were stored up to this point, and each of the items of route map information 20 are updated without adding the value ‘11’ that is already given in the route map information 20. As a result, the route map information 20 at this point is route map information having the values ‘11’, ‘10’, ‘13’, ‘X’ and ‘Y’, and after this, the complicated processing described below is performed and a process of deleting the route map information 20 having the value ‘10’ from the route map M_{2B} must be performed.

In other words, more specifically, by comparing the route maps M before and after update, the portal 2B can recognize that the values of the bus ID information that indicates new busses that have become capable of transferring information by way of portal 2A are ‘X’ and ‘Y’, and that the value of the bus ID information that indicates a bus that continues to be capable of transferring information by way of portal 2A is ‘11’.

However, since the transmission source of the update message is not clear, it is not possible to recognize that bus 10 (the value of the bus ID information is ‘10’) which existed in the past as the local bus for portal 1A, and bus 13 (the value of the bus ID information is ‘13’), which existed as the local bus for portal 3A, continue to exist. Therefore, in order for portal 2B to recognize the current state that the bus having a bus ID information value of ‘10’ no longer exists, but that the bus having a bus ID information value of ‘13’ still continues to exist, an extremely complicated process must be prepared.

However, by configuring the route map information 20 so that it includes both transfer-capable bus ID information and the transmission source portal ID information as in the case of this embodiment, then as shown in FIG. 10, by portal 2B comparing the ‘route map information 20 received from portal 1B’ with the ‘route map information 20 from among the route map information that portal 2B had up until that point that was received from portal 1B’, it is possible for portal 1B to detect that the bus 10 indicating the bus ID information having value ‘10’ that was capable of transferring information by way of portal 1A, which is a coportal, no longer exists.

Also, in portal 2B, by comparing that ‘in accordance to the present update message route information 20 will not be received from portal 3B’ with ‘route map information 20 from among the route map information that portal 2B had up until this point that was received from portal 3B’, portal 2B can detect that the bus ‘13’ that indicates bus ID information having the value ‘13’ and that is capable of transferring information by way of portal 3B (and portal 3A, which is a coportal of portal 3B) still exists. This is because, when the bus structure on the side of portal 3A has changed as seen from bus 11, portal 3B always sends an update to each portal, however, based on this, the fact that an update message is not sent from portal 3B device that the configuration of busses that are capable of transferring information by of portal 3B has not yet changed.

In this way, by including the transmission source portal ID information and not just transfer-capable bus ID information in one item of route map information 20, it is possible to easily recognize without having to use a complicated processing algorithm that the bus 10 that existed in the past as the local bus for portal 1A no longer exists, and that the bus 13 that existed in the past as the local bus for portal 3A continues to exist.

Furthermore, even when bridge 1 (see FIG. 3) that includes portal 1A and portal 1B receives an update message from both ends at nearly the same time, processing is performed from portal 1A (or portal 1B) from which the update message was received first, and processing is performed with the flow:
Network ID information 21 and local bus ID information 22 are updated→an update message is transferred to the coportal→the route map M of the coportal is updated.

After each of the above processing is finished, then similarly processing of the other update message that is received from portal 1B (or portal 1A) after that is performed with the flow:
Network ID information 21 and local bus ID information 22 are updated→an update message is transferred to the coportal→the route map M of the coportal is updated.

Therefore, even when update messages collide in the same bridge as described above, it is possible to quickly update the route maps M while avoiding various complicated processing due to the collision.

In the embodiment described above, a method of using the maximum value of the portal ID information values that indicate the portals on the local bus acquired beforehand as is as the bus ID information, or similarly a method of using the minimum value of the portal ID information values as is as the bus ID information were used as the method for setting new bus ID information, however, besides these methods other methods could be used, for example:

(a) A method of comparing the size of bytes one byte at a time from the MSB (Most Significant Bit) side of the portal ID information that indicates the local bus acquired beforehand, and using the maximum byte value or minimum byte value from this comparison as the value of the new bus ID information.

(b) A method of comparing the size of bytes one byte at a time from the LSB (Least Significant Bit) side of the portal ID information that indicates the local bus acquired beforehand, and using the maximum byte value or minimum byte value from this comparison as the value of the new bus ID information.

(c) A method of defining manufacturer ID information for identifying the manufacturer of the portal, for example, when the portal ID information (node ID information) is 64 bits, defining 6 bits from the MSB side, and defining the remaining bits after that portion as unique ID information for each of the equipment manufactured by the manufacturer, then for the remaining bits after the manufacturer ID information, comparing the size of the byte values one byte at a time from the MSB side or LSB side, and using the maximum byte value or minimum byte value from that comparison as the new bus ID information (in the case of this method, when the same portal exists for all of the bit values other than the manufacturer ID information, comparison is performed of the byte value one byte at a time from the MSB side or LSB side of the manufacturer ID information, and the maximum or minimum byte value from that comparison is used to together with the result of the comparison of the bits other than the manufacturer ID information as the new bus ID information).

By using any of these methods (a) thru (c), it is possible to generate bus ID information by a simple method and to update route map data M.

Furthermore, in the embodiment described above, the case was explained in which transfer-capable bus ID information is included in the route map information 20, however, instead of this, ‘node ID information’, which indicates a node by which a portal that stores the information can transfer information, can be include as route map information. In this case, the node ID information itself is included as route map information, so it is possible to recognize the location in a network or network group where the target node is located without having to used a complicated algorithm for acquiring node ID information that indicates each of the nodes in a network or network group.

Also, in the embodiment described above, processing for the case in which a new network group was formed by connecting a pair of network units by a bridge was explained, however, besides this, the invention can also be applied to the process of updating route maps M after a bus reset of the original network group in the case in which one or a plurality of network units is disconnected from an existing network group.

Here, basically a process similar to the process shown by the flowchart that was explained using FIG. 5 is executed as the process for updating the route maps M in this case. More specifically, after the bus reset that occurs when the bridge 3 is disconnected from the bus 14 shown in FIG. 8, new bus ID information that indicates the original bus 14 is set. In the case shown in FIG. 9, the only other portal that is connected to bus 14 is portal 1A, so bus ID information that indicates bus 14 is newly set based on the portal ID information of portal 1A.

Also, the route map M_{1A} that is stored in portal 1A is updated using the newly set bus ID information and transferred to portal 1B, after which the route map M1B in portal 1B is updated and transferred to other portals, and the update process is repeated.

Here, after a bus reset occurs, portal 1A receives an update message for the route map M_{1A} from another portal that is supposed to be on the bus 14, which is the local bus, however, when the bridge 3 is disconnected from the network group GG that is shown in FIG. 9, there is no other portal that exists on bus 14, so portal 1A does not receive that update message. That is, when an update message is sent to portal 1B from portal 1A, it is possible to recognize that bus 13 as information obtained from portal 3B that was supposed to exist no longer exists, so route map information having a value ‘3B/13’ is deleted from the route map 1B of portal 1B. The processing by this portal 1B is executed in the same was as that by portal 2B shown in FIG. 9.

Furthermore, in the embodiment described above, the case was explained in which the bus ID information that indicates each bus was set by using the portal ID information that indicates the portals connected to that bus, and then the route map M was updated, however, besides this, construction can be such that the bus ID information that indicates each of the busses in a newly formed network group can be set by the user for each bus so that values of mutual bus ID information are unique in that network group. In this case, at any node, it is necessary to have an input unit for inputting each bus ID information.

Furthermore, the present invention can be applied not only to busses that comply with the IEEE 1394 standard described above, but can also be widely applied to networks that use busses that can connect personal computers and peripheral devices, or that can connect audio/visual equipment, or can also be applied to networks such as a so-called wireless LAN (Local Area Network).

Also, the programs that correspond to the flowcharts shown in FIG. 5 can be stored on an information recording medium such as a flexible disc or hard disc, or can be obtained via the Internet or the like and stored, and by reading these programs by a general-purpose computer and executing them, the computer can function as the control unit 51 of the embodiments described above.

1-17. (canceled)

18: An information relay device that connects networks that are constructed such that they include busses that are identified by one bus ID information, and includes a number of connection devices equal to the number of networks that are directly connected to the busses of the networks, and by connecting the connection devices connects the networks that are directly connected to the connection devices, and comprising
an update device for updating the bus ID information that corresponds to the busses to which the connection devices included in the information relay device are directly connected, so that when the networks are connected together to form a new network group, the bus ID information that corresponds to the busses of the new network group is different from each other; wherein
each of the connection devices comprises a connection device ID information memory device for storing in advance connection device ID information, which is connection device ID information for identifying each connection device from another connection device, and that differs from the connection device ID information that corresponds to all of the other connection devices; and
the update device updates the bus ID information based on the connection device ID information that indicates the connection devices that are included in the information relay device and other connection devices that are directly connected to the busses to which the connection devices are directly connected, when updating the bus ID information.

19. An information relay device that connects networks that are constructed such that they include busses that are identified by one bus ID information, and includes a number of connection devices equal to the number of networks that are directly connected to the busses of the networks, and by connecting the connection devices connects the networks that are directly connected to the connection devices, and comprising
an update device for updating the bus ID information that corresponds to the busses to which the connection devices that are included in the information relay device are directly connected, so that when disconnecting any the network from an already formed network group that includes a plurality of the networks, the bus ID information that corresponds to each of the busses belonging to the network group after the network has been disconnected is different from each other in the network group after disconnection of the network; wherein
each of the connection devices comprises a connection device ID information memory device for storing in advance connection device ID information, which is connection device ID information for identifying each connection device from another connection device, and that differs from the connection device ID information that corresponds to all of the other connection devices; and
the update device updates the bus ID information based on the connection device ID information that indicates the connection devices that are included in the information relay device and other connection devices that are directly connected to the busses to which the connection devices are directly connected, when updating the bus ID information.

20. The information relay device of claim 18 or claim 19, wherein
the update device updates the bus ID information based on connection device ID information having the maximum value among the connection device ID information that indicates the connection devices that are included in the information relay device and other connection devices that are directly connected to the busses to which the connection devices are directly connected.

21. The information relay device of claim 18 or claim 19, wherein
the update device compares in order the byte values of all of the connection device ID information from the MSB (Most Significant Bit) side of the connection device ID information that indicates the connection devices that are included in the information relay device and other connection devices that are directly connected to the busses to which the connection devices are directly connected, and updates the bus ID information based on either the maximum value or the minimum value of the byte value.

22. The information relay device of claim 18 or claim 19, wherein
the update device compares in order the byte values of all of the connection device ID information from the LSB (Least Significant Bit) side of the connection device ID information that indicates the connection devices that are included in the information relay device and other connection devices that are directly connected to the busses to which the connection devices are directly connected, and updates the bus ID information based on either the maximum value or the minimum value of the byte value.

23. The information relay device of claim 18 or claim 19, wherein
the update device compares in order the byte values of partial ID information from the MSB (Most Significant Bit) side of that partial ID information, which is a part of the connection device ID information that indicates the connection devices that are included in the information relay device and other connection devices that are directly connected to the busses to which the connection devices are directly connected, and updates the bus ID information based on either the maximum value or the minimum value of the byte value.

24. The information relay device of claim 18 or claim 19, wherein
the update device compares in order the byte values of partial ID information from the LSB (Least Significant Bit) side of that partial ID information, which is a part of the connection device ID information that indicates the connection devices that are included in the information relay device and other connection devices that are directly connected to the busses to which the connection devices are directly connected, and updates the bus ID information based on either the maximum value or the minimum value of the byte value.

25. An information relay device that connects networks that are constructed such that they include busses that are identified by one bus ID information, and includes a number of connection devices equal to the number of networks that are directly connected to the busses of the networks, and by connecting the connection devices connects the networks that are directly connected to the connection devices, and comprising
an update device for updating the bus ID information that corresponds to the busses to which the connection devices included in the information relay device are directly connected, so that when the networks are connected together to form a new network group, the bus ID information that corresponds to the busses of the new network group is different from each other; wherein
the connection device further comprises a control information memory device for storing control information, which is control information for controlling the exchange of information between the networks and that includes unit control information or a plurality of control information that comprises the bus ID information that indicates the busses inside the network group over which the connection device is capable of exchanging the information, and connection ID information that indicates other connection devices that output the bus ID information to the connection device; and
the update device updates the bus ID information as well as updates the control information by updating the unit control information using the updated bus ID information.

26. An information relay device that connects networks that are constructed such that they include busses that are identified by one bus ID information, and includes a number of connection devices equal to the number of networks that are directly connected to the busses of the networks, and by connecting the connection devices connects the networks that are directly connected to the connection devices, and comprising
an update device for updating the bus ID information that corresponds to the busses to which the connection devices that are included in the information relay device are directly connected, so that when disconnecting any the network from an already formed network group that includes a plurality of the networks, the bus ID information that corresponds to each of the busses belonging to the network group after the network has been disconnected is different from each other in the network group after disconnection of the network; wherein
the connection device further comprises a control information memory device for storing control information, which is control information for controlling the exchange of information between the networks and that includes unit control information or a plurality of control information that comprises the bus ID information that indicates the busses inside the network group over which the connection device is capable of exchanging the information, and connection ID information that indicates other connection devices that output the bus ID information to the connection device; and
the update device updates the bus ID information as well as updates the control information by updating the unit control information using the updated bus ID information.

27. The information relay device of claim 25 or claim 26, further comprising:
a detection device for detecting whether or not update information, which is sent from any other connection device after the bus ID information and the control information has been updated and that includes the unit control information that was updated in the other connection device, includes bus ID information that is the same as the any of the bus ID information that is included in the control information that is stored in the connection devices of the information relay device; and
a deletion device for deleting a loop condition in the connection of the busses in the network group when the update information includes bus ID information that is the same as any other the bus ID information that is included in the control information that is stored inside the connection devices included in the information relay device.

28. An information relay method that is executed by an information relay device that connects networks that are constructed such that they include busses that are identified by one bus ID information, and includes a number of connection devices equal to the number of networks that are directly connected to the busses of the networks, and by connecting the connection devices connects the networks that are directly connected to the connection devices, and comprising
an update process of updating the bus ID information that corresponds to the busses to which the connection devices included in the information relay device are directly connected, so that when the networks are connected together to form a new network group, the bus ID information that corresponds to the busses of the new network group is different from each other; wherein
each of the connection devices comprises a connection device ID information memory device for storing in advance connection device ID information, which is connection device ID information for identifying each connection device from another connection device, and that differs from the connection device ID information that corresponds to all of the other connection devices; and
the update process updates the bus ID information based on the connection device ID information that indicates the connection devices that are included in the information relay device and other connection devices that are directly connected to the busses to which the connection devices are directly connected, when updating the bus ID information.

29. An information relay method that is executed by an information relay device that connects networks that are constructed such that they include busses that are identified by one bus ID information, and includes a number of connection devices equal to the number of networks that are directly connected to the busses of the networks, and by connecting the connection devices connects the networks that are directly connected to the connection devices, and comprising
an update device for updating the bus ID information that corresponds to the busses to which the connection devices that are included in the information relay device are directly connected, so that when disconnecting any the network from an already formed network group that includes a plurality of the networks, the bus ID information that corresponds to each of the busses belonging to the network group after the network as been disconnected is different from each other in the network group after disconnection of the network; wherein
each of the connection devices comprises a connection device ID information memory device for storing in advance connection device ID information, which is connection device ID information for identifying each connection device from another connection device, and that differs from the connection device ID information that corresponds to all of the other connection devices; and
the update process updates the bus ID information based on the connection device ID information that indicates the connection devices that are included in the information relay device and other connection devices that are directly connected to the busses to which the connection devices are directly connected, when updating the bus ID information.

30. An information relay program that causes a computer, which is included in an information relay device that connects networks that are constructed such that they include busses that are identified by one bus ID information, and includes a number of connection devices equal to the number of networks that are directly connected to the busses of the networks, and by connecting the connection devices connects the networks that are directly connected to the connection devices, to function as
an update device for updating the bus ID information that corresponds to the busses to which the connection devices included in the information relay device are directly connected, so that when the networks are connected together to form a new network group, the bus ID information that corresponds to the busses of the new network group is different from each other; wherein
each of the connection devices comprises a connection device ID information memory device for storing in advance connection device ID information, which is connection device ID information for identifying each connection device from another connection device, and that differs from the connection device ID information that corresponds to all of the other connection devices; and
the update device updates the bus ID information based on the connection device ID information that indicates the connection devices that are included in the information relay device and other connection devices that are directly connected to the busses to which the connection devices are directly connected, when updating the bus ID information.

31. An information relay program that causes a computer, which is included in an information relay device that connects networks that are constructed such that they include busses that are identified by one bus ID information, and includes a number of connection devices equal to the number of networks that are directly connected to the busses of the networks, and by connecting the connection devices connects the networks that are directly connected to the connection devices, to function as
an update device for updating the bus ID information that corresponds to the busses to which the connection devices that are included in the information relay device are directly connected, so that when disconnecting any the network from an already formed network group that includes a plurality of the networks, the bus ID information that corresponds to each of the busses belonging to the network group after the network as been disconnected is different from each other in the network group after disconnection of the network; wherein
each of the connection devices comprises a connection device ID information memory device for storing in advance connection device ID information, which is connection device ID information for identifying each connection device from another connection device, and that differs from the connection device ID information that corresponds to all of the other connection devices; and
the update device updates the bus ID information based on the connection device ID information that indicates the connection devices that are included in the information relay device and other connection devices that are directly connected to the busses to which the connection devices are directly connected, when updating the bus ID information.

32. An information recording medium on which the information relay program of claim 30 or claim 31 is recorded so that it can be read by the computer.
